(19) United States
(12) Patent Application Publication
(10) Pub. No.: US 2018/0186021 A1
(43) Pub. Date: Jul. 5, 2018

(54) AUTOMATIC CITRUS-FRUIT CUTTING SYSTEM AND COCKTAIL MACHINE COMPRISING SAME

(71) Applicant: BLENDBOW, Neuilly Sur Seine (FR)

(72) Inventor: Morgan FELLOUS, Neuilly Sur Seine (FR)

(21) Appl. No.: 15/740,979

(22) PCT Filed: Jun. 10, 2016
(86) PCT No.: PCT/FR2016/051416

§ 371 Date: Dec. 29, 2017

(30) Foreign Application Priority Data
Jun. 30, 2015 (FR) 1556130

(51) Int. Cl. B26D 3/26; B26D 7/06; B26D 7/18

(52) U.S. Cl. CPC B26D 3/26; B26D 7/18; B26D 7/0608

(57) ABSTRACT

An automatic citrus fruit cutting system includes a reservoir for loading citrus fruits, the bottom of the reservoir forming a hopper opening onto a downward pipe leading into a citrus fruit pushing chamber, the pushing chamber being having a pushing unit having a pushing face for pushing the citrus fruit into the pushing chamber along a pushing direction. The system further includes a blade assembly including blades radially arranged and centered with respect to the pushing direction of the pushing unit, forming chambers for pieces of cut fruit, the pushing face having notches complementary to the blades so the pushing unit pushes the citrus fruit on the blade assembly to cut the citrus fruit into pieces. The blade assembly further includes a unit for rotating the blades so as to dispense the pieces of citrus fruit contained in the chambers for pieces of cut citrus fruit, one by one.

The present invention relates to the field of machines for cutting citrus fruits into pieces, and in particular to an automatic citrus fruit cutting system and to a cocktail machine comprising said automatic citrus fruit cutting system.

Many drinks with or without alcohol require citrus fruits, such as lemons or oranges, to be cut so as to be made, such a cutting being traditionally carried out manually by a user using a knife. However, such a manual cutting is generally not uniform, the pieces of cut citrus fruit generally not having the same size and, where the user is a bartender, is time-consuming, which reduces the number of drinks which can be served by the bartender in a given time. There is therefore a need for an automatic citrus fruit cutting system so as to make the citrus fruit cutting automatic and uniform and to increase the number of drinks which can be served in a given time by a bartender.

The French patent application FR2388651A1 discloses a machine for cutting bulb-shaped products, such as celeriac, said machine comprising a dividing tube comprising at an end a pushing piston and at the other end a dividing knife, the dividing tube being linked through a connecting tube to a feeding hopper, the piston being actuated through its pushing rod and a connecting rod by a driving wheel connected to a pulley mounted on the shaft of an electric motor. However, such a cutting machine is not specially designed for cutting citrus fruits. Moreover, such a cutting machine does not allow to automatically dispense the pieces of cut citrus fruit one by one into a container. Finally, such a cutting machine does not allow to make only one citrus fruit at a time fall into the dividing tube so as to avoid the case where two citrus fruits are simultaneously pushed by the pushing piston toward the dividing knife.

The present invention aims to overcome the drawbacks of the prior art, by providing an automatic citrus fruit cutting system allowing to automatically cut citrus fruits into pieces, preferably equal, using citrus fruit pushing means and a blade assembly comprising blades, said automatic citrus fruit cutting system also allowing to dispense the pieces of cut citrus fruit one by one into a container using means for rotating the blades, which allows to cut the citrus fruits efficiently and uniformly and to increase the number of drinks which can be served in a given time by a bartender.

The automatic citrus fruit cutting system can also comprise a device for blocking/releasing citrus fruits in order to make only one citrus fruit at a time fall between the citrus fruit pushing means and the blade assembly.

The present invention also provides a cocktail machine comprising said automatic citrus fruit cutting system.

An object of the present invention is therefore an automatic citrus fruit cutting system comprising a reservoir for loading citrus fruits, the bottom of which constitutes a hopper opening onto a downward pipe which leads into a citrus fruit pushing chamber, the downward pipe being configured such that only one citrus fruit at a time falls by gravity into the citrus fruit pushing chamber, the citrus fruit pushing chamber being provided with citrus fruit pushing means having a pushing face for pushing the citrus fruit into the citrus fruit pushing chamber along a pushing direction, the citrus fruit pushing chamber being dimensioned to channel the citrus fruit pushing along the pushing direction, the citrus fruit pushing means having a rest position in which the pushing face is located upstream from the citrus fruit point of fall into the citrus fruit pushing chamber along the pushing direction, the automatic citrus fruit cutting system further comprising a blade assembly comprising blades which are radially arranged and are centered with respect to the pushing direction of the citrus fruit pushing means so as to form chambers of pieces of cut citrus fruit, the cutting edge of the blades facing the pushing face of the citrus fruit pushing means, said pushing face having notches complementary to the blades such that the citrus fruit pushing means is configured to push the citrus fruit on the blade assembly in order to cut the citrus fruit into pieces completely, characterized in that the blade assembly further comprises means for rotating the blades so as to dispense sequentially the pieces of citrus fruit contained in the cut citrus fruit pieces chambers.

Preferably, the pieces of citrus fruit contained in the cut citrus fruit pieces chambers are dispensed one by one.

It should be noted that the diameter of the downward pipe is greater than the average size of the type of citrus fruit to be cut, and preferably less than twice the average size of the type of citrus fruit to be cut, such that only one citrus fruit at a time falls into the citrus fruit pushing chamber.

Once a citrus fruit has fallen into the citrus fruit pushing chamber when the pushing face of the citrus fruit pushing means is in rest position, the pushing face of the citrus fruit pushing means thus pushes the citrus fruit onto the blades of the blade assembly so as to cut the citrus fruit, then the means for rotating the blades rotate the blades according to a rotation axis which is the pushing direction, the pieces of cut citrus fruit thus falling one by one from the blade assembly by gravity into a container arranged under the blade assembly.

The complementary grooves formed in the pushing face allow the pushing face to fit into the blade assembly so as to allow the citrus fruit to be cut completely along the pushing direction, which allows to cut the citrus fruits efficiently and to increase the number of drinks which can be served in a given time by a bartender.

The means for rotating the blades also allow to dose the amount of pieces of cut citrus fruit to be dispensed into the container according to their desired number.

According to a particular feature of the invention, the blade assembly comprises at least three blades which are equidistantly spaced in order to obtain equal pieces of cut citrus fruit.

The automatic citrus fruit cutting system thus allows to cut the citrus fruits uniformly, preferably into four or eight equal pieces of citrus fruit.

According to a particular feature of the invention, the pushing face of the citrus fruit pushing means is concave with a concavity directed toward the blade assembly.

The concavity of the pushing face is thus complementary to the substantially round shape of a citrus fruit, which allows to optimize the pushing phase of the citrus fruit onto the blades by the citrus fruit pushing means.

According to a particular feature of the invention, the citrus fruit pushing means is a cylinder disposed in the citrus fruit pushing chamber and pushing the pushing face toward the blade assembly.

The cylinder thus allows to move the pushing face into the citrus fruit pushing chamber so as to push the citrus fruit toward the blades.

The moving speed of the cylinder is preferably very fast, the cylinder taking preferably less than four seconds to push a citrus fruit onto the blades.

According to a particular feature of the invention, the cylinder is actuated by gears driven by a first electric motor.

The rotation of the first electric motor thus rotates the gears, which drives the cylinder to move into the citrus fruit pushing chamber.

The pushing face of the cylinder is, for example, screwed on a screw secured to the gears, the rotation of the screw driving the pushing face to move along the screw.

It should be noted that the citrus fruit pushing means could also be a piston actuated through its pushing rod and a connecting rod by a driving wheel connected to a pulley mounted on the shaft of an electric motor, without departing from the scope of the present invention.

According to a particular feature of the invention, the automatic citrus fruit cutting system further comprises a citrus fruit transporting device in the downward pipe in order to transport the citrus fruits contained in the loading reservoir toward the downward pipe.

Thus, the citrus fruits contained in the loading reservoir are automatically transported toward the downward pipe so as to be cut afterwards one by one in the blade assembly.

According to a particular feature of the invention, the citrus fruit transporting device comprises a wheel driven by a second electric motor, the axis of said wheel being disposed under the hopper of the loading reservoir and a part of said wheel protruding through a hole formed in the hopper, the surface of said wheel being configured to drive a citrus fruit. The surface of the wheel can thus be textured so as to grip the skin of the citrus fruit better and thus to drive it.

Thus, the wheel in contact with a part of the citrus fruits contained in the loading reservoir allows to automatically make the citrus fruits go down toward the downward pipe.

It should be noted that the citrus fruit transporting device could also be a device for causing the hopper to vibrate, without departing from the scope of the present invention.

According to a particular feature of the invention, the automatic citrus fruit cutting system further comprises a device for blocking/releasing citrus fruits in the downward pipe configured to make only one citrus fruit at a time fall into the citrus fruit pushing chamber.

Thus, only one citrus fruit at a time falls into the citrus fruit pushing chamber, which allows to avoid two citrus fruits falling at the same time into the citrus fruit pushing chamber and the cut pieces being not uniform, or the citrus fruit pushing means getting stuck.

According to a particular feature of the invention, the device for blocking/releasing citrus fruits comprises a blocking blade disposed in the downward pipe and actuated by a third electric motor.

Thus, the blocking blade allows to block the citrus fruits which are above it when it is in the horizontal closed position, and to release only one citrus fruit when it is in the lowered open position.

According to a particular feature of the invention, the automatic citrus fruit cutting system further comprises a centering jig for centering citrus fruits which is disposed upstream from the blades of the blade assembly in order to center the citrus fruit on the blades when the citrus fruit is pushed by the citrus fruit pushing means.

Thus, the centering jig, preferably disposed appended to the entry of the blade assembly, allows to recenter the citrus fruit on the blades in order that, whatever the size and the shape of the citrus fruit, the cutting is centered and the pieces of cut citrus fruit are uniform.

According to a particular feature of the invention, the means for rotating the blades comprise a toothed wheel driven by a fourth electric motor and meshing with teeth formed on the periphery of the blade assembly.

Thus, the rotation of the fourth electric motor rotates the blades assembly on a rotation axis which is the pushing direction, the pieces of cut citrus fruit thus falling one by one by gravity during rotation of the blade assembly, which allows the pieces of citrus fruit to be automatically dispensed and dosed accurately.

It should be noted that the four electric motors of the automatic citrus fruit cutting system are, preferably, driven by one or more electronic cards which comprise each one of a processor, a microprocessor, a microcontroller, a digital signal processor (DSP), or a programmable logic component such as a field programmable gate array (FPGA) or an application-specific integrated circuit (ASIC).

According to a particular feature of the invention, the automatic citrus fruit cutting system further comprises a protection housing disposed around the blade assembly, the protection housing comprising a lower opening for releasing the pieces of citrus fruit contained in the cut citrus fruit pieces chambers.

Thus, the protection housing allows to protect the user from cutting himself/herself with the blades, the lower opening of the protection housing allowing the pieces of cut citrus fruit to fall one by one by gravity into a container arranged under said lower opening.

According to a particular feature of the invention, the protection housing is removable in order for the blade assembly to be cleaned easily.

The protection housing can thus be removed, or opened by means of a door, in order for the blades of the automatic citrus fruit cutting system to be cleaned easily.

Another object of the present invention is a cocktail machine comprising an automatic citrus fruit cutting system according to the present invention.

The cocktail machine thus allows cocktails to be made, for example by automatically dosing liquids and/or ingredients in a container, the automatic citrus fruit cutting system allowing to automatically cut citrus fruits, such as lemons, then to automatically dispense the pieces of cut citrus fruit into the container.

To better illustrate the object of the present invention, a preferred embodiment will be described below, for illustrative and non-limiting purposes, in reference to the appended drawings.

In these drawings:

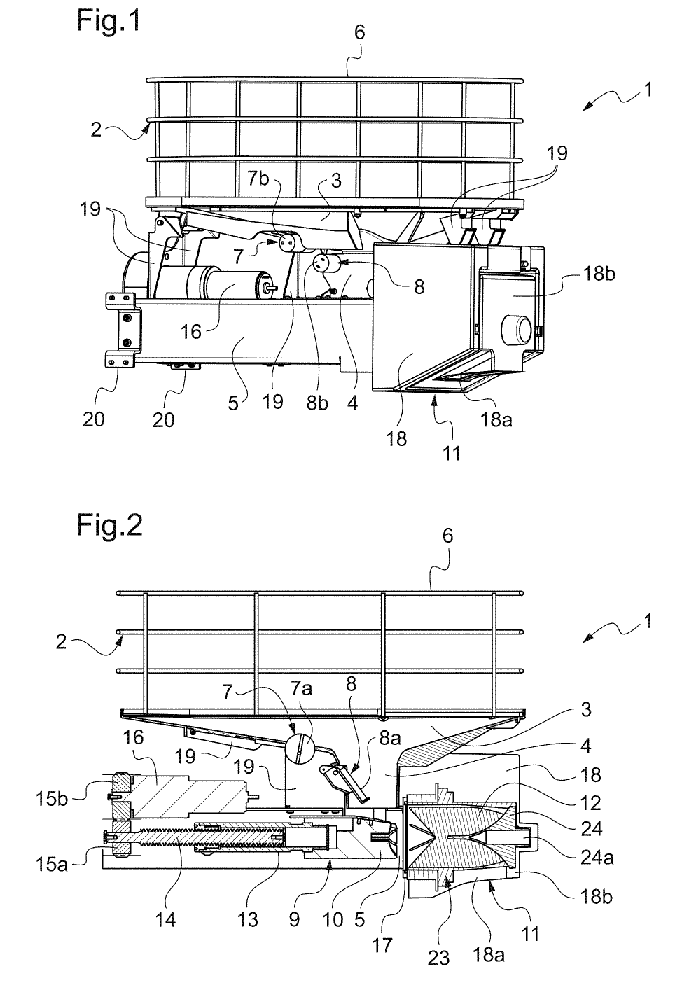

FIG. 1 is a perspective view of an automatic citrus fruit cutting system according to the present invention;

FIG. 2 is a vertical cross-sectional view of the automatic citrus fruit cutting system of FIG. 1;

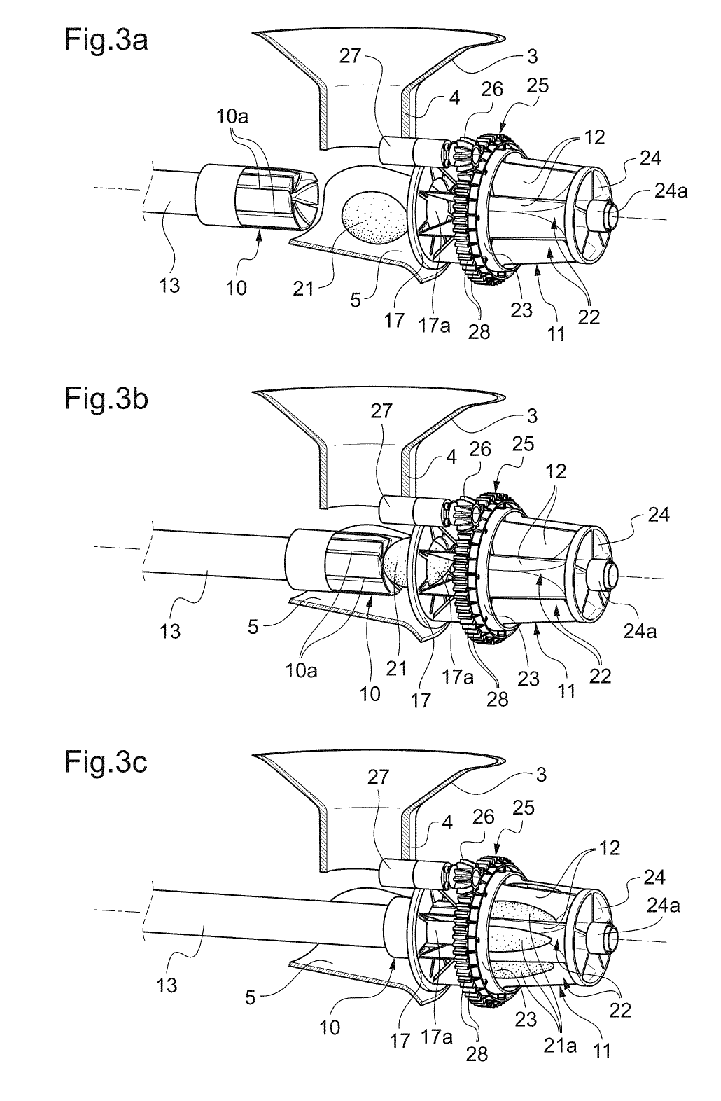

FIG. 3a is a perspective view of the citrus fruit pushing chamber and of the blade assembly of the automatic citrus fruit cutting system of FIG. 1 when the cylinder is in rest position;

FIG. 3b is a perspective view of the citrus fruit pushing chamber and of the blade assembly of the automatic citrus fruit cutting system of FIG. 1 when the cylinder pushes the citrus fruit up to a centering jig; and

FIG. 3c is a perspective view of the citrus fruit pushing chamber and of the blade assembly of the automatic citrus fruit cutting system of FIG. 1 when the cylinder pushes the citrus fruit into the blade assembly.

With reference to FIGS. 1 and 2, it can be seen that an automatic citrus fruit cutting system 1 according to the present invention is shown therein.

The automatic citrus fruit cutting system 1 comprises a reservoir for loading citrus fruits 2, the bottom of which constitutes a hopper 3 opening onto a downward pipe 4 which leads into a citrus fruit pushing chamber 5.

A vertical holding grid 6 is disposed all around the edge of the hopper 3 so as to hold citrus fruits contained in the reservoir for loading citrus fruits 2, the citrus fruits not being shown in FIGS. 1 and 2 so as not to overload the drawings.

The automatic citrus fruit cutting system 1 further comprises a citrus fruit transporting device 7 in order to automatically transport the citrus fruits contained in the loading reservoir 2 toward the downward pipe 4.

The citrus fruit transporting device 7 comprises a wheel 7a rotatably driven by a second electric motor 7b, the axis of said wheel 7a being disposed under the hopper 3 of the loading reservoir 2 and a part of said wheel 7a protruding through a hole formed in the hopper 3. The external surface of the wheel 7a is preferably textured, for example in silicone, in rubber or another texturing compatible with foodstuffs, configured to grip the citrus fruit in order to drive it.

Thus, the wheel 7a in rotation and in contact with a part of the citrus fruits contained in the loading reservoir 2 allows to automatically make the citrus fruits go down into the downward pipe 4.

The rotation speed of the second electric motor 7b is, preferably, between 50 and 150 revolutions per minute.

It should be noted that the citrus fruit transporting device 7 could also be a device for causing the hopper to vibrate, without departing from the scope of the present invention.

The automatic citrus fruit cutting system 1 further comprises a device for blocking/releasing citrus fruits 8 in the downward pipe 4, configured to make only one citrus fruit at a time fall into the citrus fruit pushing chamber 5.

The device for blocking/releasing citrus fruits 8 comprises a blocking blade 8a disposed in the downward pipe 4 and actuated by a third electric motor 8b, the rotor of the third electric motor 8b being connected to one of the edges of the blocking blade 8a such that the rotation of said rotor rotates the blocking blade 8a, around the axis of said rotor, in the downward pipe 4.

Thus, the blocking blade 8a allows to lock the citrus fruits which are above it when it is in the horizontal closed position, and to release only one citrus fruit when it is in the lowered open position.

The rotation speed of the third electric motor 8b is, preferably, between 15 and 100 revolutions per minute. The motor 8b will be configured to support the weight of the citrus fruits on the blocking blade 8a and to avoid their weight from triggering the opening of the blocking blade 8a.

It should be noted that the device for blocking/releasing citrus fruits 8 could also be any blocking/releasing system, such as a mobile hatch or a mobile finger, without departing from the scope of the present invention.

The diameter of the downward pipe 4 is greater than the average size of the type of citrus fruit to be cut, and preferably less than twice the average size of the type of citrus fruit to be cut, in order to allow the citrus fruit going down into the downward pipe to be channeled.

The citrus fruit pushing chamber 5 is provided with citrus fruit pushing means 9 having a pushing face 10 for pushing a citrus fruit contained in the citrus fruit pushing chamber 5 according to a horizontal pushing direction.

It should be noted that the pushing direction could also be tilted, without departing from the scope of the present invention.

The citrus fruit pushing means 9 has a rest position in which the pushing face 10 is located upstream, along the pushing direction, from the citrus fruit point of fall into the citrus fruit pushing chamber 5.

The automatic citrus fruit cutting system 1 further comprises a blade assembly 11 comprising blades 12, the cutting edges of which face the pushing face 10 of the citrus fruit pushing means 9, the blade assembly 11 being described in more detail with respect to FIGS. 3a, 3b and 3c.

Thus, once a citrus fruit has fallen into the citrus fruit pushing chamber 5 when the citrus fruit pushing means 9 is in rest position, the pushing face 10 of the citrus fruit pushing means 9 pushes the citrus fruit on the blades 12 of the blade assembly 11 so as to cut the citrus fruit into pieces.

The citrus fruit pushing means 9 comprises a cylinder 13 disposed in the citrus fruit pushing chamber 5, the cylinder 13 being fixed to the pushing face 10 and allowing to move the pushing face 10 into the citrus fruit pushing chamber 5 along the pushing direction so as to push a citrus fruit toward the blades 12.

The cylinder 13 is screwed on a screw 14, one end of which is fixed to a first gear 15a meshing with a second gear 15b, the second gear 15b being driven by a first electric motor 16.

Thus, the rotation of the first electric motor 16 rotates the first and second gears 15a and 15b, which rotates the screw 14, which causes the cylinder 13 to move into the citrus fruit pushing chamber 5, according to the rotation direction of the first electric motor 16.

The rotation speed of the first electric motor 16 is, preferably, comprised between 120 and 500 revolutions per minute.

The moving speed of the cylinder 13 is very fast, the cylinder 13 taking preferably less than four seconds to push a citrus fruit on the blades 12.

It should be noted that the citrus fruit pushing means 9 could also be a piston actuated through its rod and a connecting rod by a driving wheel connected to a pulley mounted on the shaft of an electric motor, or any other pushing means, without departing from the scope of the present invention which is not limited in this respect.

The automatic citrus fruit cutting system 1 further comprises a citrus fruit centering jig 17 arranged upstream from the blades 12 of the blade assembly 11, preferably appended to the entry of the blade assembly 11 in the citrus fruit pushing direction, in order to center the citrus fruit on the blades 12 when pushing the citrus fruit by the citrus fruit pushing means 9.

The automatic citrus fruit cutting system 1 further comprises a protection housing 18 arranged around the blade assembly 11, the protection housing 18 comprising a lower opening 18a for the passage of cut citrus fruit pieces.

The protection housing 18 thus allows to protect the user as regards to a cut by the blades 12.

The protection housing 18 comprises a removable door 18b in order to allow the cleaning of the blades 12 of the blade assembly 11.

The loading reservoir 2, the citrus fruit pushing chamber 5 and the protection housing 18 are fixed together by frame elements 19.

The automatic citrus fruit cutting system 1 also comprises fixing elements 20 allowing for example to fix said system 1 on another machine, for example a cocktail machine.

When referring to FIGS. 3a, 3b and 3c, it can be seen that the cylinder 13 and the blade assembly 11 of the automatic citrus fruit cutting system 1 are shown at different pushing steps of a lemon 21 by the cylinder 13.

It should be noted that the drawings of FIGS. 3a, 3b and 3c were simplified, especially by not showing the device for blocking/releasing citrus fruits 8 and the protection housing 18, and by showing only part of the citrus fruit pushing chamber 5, so as to facilitate the user understanding. It is obvious that the citrus fruit pushing chamber 5 is dimensioned, substantially like the downward pipe 4, namely with dimensions smaller than twice the average size of a citrus fruit and greater than the average size of a citrus fruit, in order to channel the displacement of the citrus fruit.

The blade assembly 11 comprises eight blades 12, radially arranged and centered with respect to the pushing direction of the cylinder 13 to form chambers 22 for cut citrus fruit pieces.

The eight blades 12, in the non-limiting example shown, are radially equidistantly spaced so as to obtain eight equal cut citrus fruit pieces.

It should be noted that the blade assembly 11 could also comprise any number of blades 12, without departing from the scope of the present invention.

The eight blades 12 are maintained in position by first and second blade supports 23 and 24, the first blade support 23 being circular and being arranged around the blades 12, at the entry of the blade assembly 11 along the pushing direction, and the second blade support 24 being circular and arranged at the end of the blades 12 opposite to the cylinder 13, the second blade support 24 comprising a projection 24a configured to removably engage a complementary notch formed in the removable door 18b of the protection housing 18.

When referring in particular to FIG. 3a, it can be seen that the lemon 21, coming from the hopper 3 through the downward pipe 4, lies at the bottom of the citrus fruit pushing chamber 5, the cylinder 13 being in the rest position.

The rest position of the cylinder 13 is such that the pushing face 10 is located upstream from the fall point of the lemon 21 into the citrus fruit pushing chamber 5, along the pushing direction toward the blade assembly 11.

The pushing face 10 of the cylinder 13 comprises notches 10a complementary with the blades 12 such that the citrus fruit pushing means 9 is configured to entirely push a citrus fruit on the blade assembly 11 in order to cut the citrus fruit in eight equal pieces along the pushing direction.

When referring in particular to FIG. 3b, it can be seen that the cylinder 13 pushes the lemon 21 up to the centering jig 17.

The pushing face 10 of the cylinder 13 is concave with a concavity directed toward the blade assembly 11, in order to further improve the channelization of the citrus fruit during its displacement, by closely fitting its external rounded shape.

The concavity of the pushing face 10 is thus complementary to the substantially round shape of the lemon 21, which allows to optimize the lemon 21 pushing phase on the blades 12.

The centering jig 17, arranged upstream from the blades 12, allows to recenter the lemon 21 on the blades 12 so that, whatever the size and shape of the lemon, the cut is centered and the cut lemon pieces are uniform.

The centering jig 17 comprises a circular through hole 17a whose size is substantially equal to the average size of a lemon, the pushing face 10 being also configured to pass through the circular through hole 17a of the centering jig 17. The centering jig 17 will advantageously be flexible/deformable to adapt to different sizes of citrus fruits.

When referring in particular to FIG. 3c, it can be seen that the cylinder 13 pushes the lemon 21 into the blade assembly 11.

The pushing face 10 of the cylinder 13 enters into the blade assembly 11 and thereby pushes the lemon 21 along the blades 12, so that the lemon 21 is cut in eight cut lemon pieces 21a housed respectively in the chambers 22, the blades 12 entering into the complementary notches 10a of the pushing face 10 during the cylinder 13 displacement. The notches 10a are thus at least as deep in the pushing direction as the blades are long in the pushing direction, so as to guarantee that the citrus fruit is entirely cut in the pushing direction.

The blade assembly 11 further comprises means for rotating the blades 12 in order to dispense one by one the lemon pieces 21a contained in the chambers 22.

The means for rotating the blades 25 comprise a toothed wheel 26 driven by a fourth electric motor 27 and meshing with teeth 28 formed on the periphery of the first blade support 23.

The rotation of the fourth electric motor 27 thus rotates the blade assembly 11 around a rotation axis which is the cylinder 13 pushing direction, the pieces 21a of cut lemon thus falling one by one by gravity during rotation of the blade assembly 11 by passing through the lower opening 18a of the protection housing 18, which allows an automatic dispensing of pieces 21a of lemon and a precise dosage according to the expected drink.

The rotation speed of the fourth electric motor 27 is preferably comprised between 20 and 250 revolutions per minute.

It should be noted that the four electric motors 7b, 8b, 16 and 27 of the automatic citrus fruit cutting system 1 are preferably driven by one or several electronic cards (not shown on figures) which comprise each one among a processor, a microprocessor, a microcontroller, a digital signal processor (DSP), or a logical programmable component such as a field programmable gate array (FPGA) or an application specific integrated circuit (ASIC).

The present invention also relates to a cocktail machine comprising an automatic citrus fruit cutting system 1 according to the present invention.

Thus, the cocktail machine allows to make cocktails, for example by automatic dosage of liquids and/or ingredients in a container, the automatic citrus fruit cutting system 1 allowing to automatically cut citrus fruits such as lemons 21 and then to automatically dispense the cut citrus fruit pieces 21a in the container arranged below the lower opening 18a of the protection housing 18.

1-14. (canceled)

15. An automatic citrus fruit cutting system comprising a reservoir for loading citrus fruits, the bottom of the reservoir constituting a hopper opening onto a downward pipe which leads into a citrus fruit pushing chamber, the downward pipe being configured such that only one citrus fruit at a time falls by gravity into the citrus fruit pushing chamber, the citrus fruit pushing chamber being provided with citrus fruit pushing means having a pushing face for pushing a citrus fruit into the citrus fruit pushing chamber along a pushing direction, the citrus fruit pushing chamber being dimensioned to channel the citrus fruit pushing along the pushing direction, the citrus fruit pushing means having a rest position in which the pushing face is located upstream from the citrus fruit point of fall into the citrus fruit pushing chamber along the pushing direction, the automatic citrus fruit cutting system further comprising a blade assembly comprising blades which are radially disposed and are centered with respect to the pushing direction of the citrus fruit pushing means so as to form chambers for pieces of cut citrus fruit, the cutting edge of the blades facing the pushing face of the citrus fruit pushing means, the pushing face having notches complementary to the blades such that the citrus fruit pushing means is configured to push the citrus fruit on the blade assembly in order to cut the citrus fruit into pieces completely, wherein the blade assembly further comprises means for rotating the blades so as to dispense sequentially the pieces of citrus fruit contained in each of the cut citrus fruit pieces chambers.

16. The automatic citrus fruit cutting system according to claim 15, wherein the blade assembly comprises at least three blades which are equidistantly spaced.

17. The automatic citrus fruit cutting system according to claim 15, wherein the pushing face of the citrus fruit pushing means is concave with a concavity directed toward the blade assembly.

18. The automatic citrus fruit cutting system according to claim 15, wherein the citrus fruit pushing means is a cylinder disposed in the citrus fruit pushing chamber and pushing the pushing face toward the blade assembly.

19. The automatic citrus fruit cutting system according to claim 18, wherein the cylinder is actuated by gears driven by a first electric motor.

20. The automatic citrus fruit cutting system (1) according to claim 15, wherein the automatic citrus fruit cutting system further comprises a citrus fruit transporting device in the downward pipe in order to transport the citrus fruits contained in the loading reservoir toward the downward pipe.

21. The automatic citrus fruit cutting system (1) according to claim 20, wherein the citrus fruit transporting device comprises a wheel driven by a second electric motor, the axis of the wheel being disposed under the hopper of the loading reservoir and a part of the wheel protruding through a hole formed in the hopper, the surface of the wheel being configured to drive a citrus fruit.

22. The automatic citrus fruit cutting system according to claim 15, wherein the automatic citrus fruit cutting system further comprises a device for blocking/releasing citrus fruits in the downward pipe configured to make only one citrus fruit at a time fall into the citrus fruit pushing chamber.

23. The automatic citrus fruit cutting system (1) according to claim 22, wherein the device for blocking/releasing citrus fruits comprises a blocking blade disposed in the downward pipe and actuated by a third electric motor.

24. The automatic citrus fruit cutting system according to claim 15, wherein the automatic citrus fruit cutting system further comprises a jig for centering citrus fruits which is disposed upstream from the blades of the blade assembly in order to center the citrus fruit on the blades when the citrus fruit is pushed by the citrus fruit pushing means.

25. The automatic citrus fruit cutting system according to claim 15, wherein the means for rotating the blades comprises a toothed wheel driven by a fourth electric motor and meshing with teeth formed on the periphery of the blade assembly.

26. The automatic citrus fruit cutting system according to claim 15, wherein the automatic citrus fruit cutting system further comprises a protection housing disposed around the blade assembly, the protection housing comprising a lower opening for releasing the pieces of citrus fruit contained in the cut citrus fruit pieces chambers.

27. The automatic citrus fruit cutting system according to claim 26, wherein the protection housing is removable in order for the blade assembly to be cleaned easily.

28. A cocktail machine comprising an automatic citrus fruit cutting system according to claim 15.
